(19) United States
(12) Patent Application Publication
(10) Pub. No.: US 2008/0029004 A1
(43) Pub. Date: Feb. 7, 2008

(54) Injection system and manifold device

(76) Inventor: Bruce Bragg, Las Vegas, NV (US)

Correspondence Address: ROBERT RYAN MORISHITA;MORISHITA LAW FIRM, LLC, 3800 HOWARD HUGHES PKWY,, SUITE 850, LAS VEGAS, NV, 89169, US

(21) Appl. No.: 11/491,382

(22) Filed: Jul. 20, 2006

(51) Int. Cl. A01C 23/00

(52) U.S. Cl. 111/127

(57) ABSTRACT

An injection system includes an injector pump delivering a mixture of polymer and water from a mixing tank. Optionally, a surge tank is provided to reduce pressure hammer effects. The mixture is delivered by the injector pump to a manifold device that includes a commutator valve receiving the mixture through an inlet and discharging the mixture through two or more outlet ports. An actuator controls the flow of the mixture through the commutator valve to create pulses in the mixture. Optionally, the actuator is controlled by a controller. The mixture is delivered from the outlet ports to nozzle arrays.

### FIELD OF THE INVENTION

The present invention relates to the injection of polymer beneath a ground surface. More specifically, the present invention is an injection system and a manifold device for an injection system creating a pulsed injection flow.

### BACKGROUND OF THE INVENTION

It is often desirable to inject polymer beneath a ground surface. For example, different polymers injected at different densities and depths could aid in controlling water absorption, erosion, and dust.

U.S. Pat. Nos. 5,394,812 and 5,741,090 are both directed to injection systems and devices. These systems disclose the injection of hydrophilic polymer into a ground surface so that irrigation water applied to the ground surface may be absorbed by the polymer and released in a gradual manner.

The drawback to these systems and devices is that they are not efficient. Moreover, while these systems may be sufficient for applications where the goal is control of water absorption, these systems are inadequate for other applications such as the injection of time-release fertilizers, time-release chemicals, anti-static agents, or other applications.

Therefore, there is a need in the art for an injection system and a manifold device for an injection system creating a pulsed injection flow.

### SUMMARY OF THE INVENTION

The present invention is a manifold device and injector system including a manifold device for injecting a material into a ground surface. A multi-port manifold device for an injector device receives a pressurized inflow of material. Optionally, the inflow is a mixture of polymer and water in the form of a liquid, gel, or the like. In another optional embodiment, the inflow is a dry or solid material, optionally in the form of particles. The manifold device includes a commutator valve having an inlet in communication with the inflow and at least two outlet ports. A first nozzle array communicates with one of the outlet ports and a second nozzle array communicates with a different outlet port.

An actuator communicates with the commutator valve. The actuator directs a pulse of the inflow through the commutator valve to a selected outlet port. In an optional embodiment with two outlet ports, the actuator may alternate between the outlet ports to create a pulsed output. Optionally, the device includes a controller in communication with the actuator to select an outlet port through which a pulse of the inflow is delivered.

In an optional embodiment, the manifold device further includes an impeller disposed between the commutator valve and one or both of the nozzle arrays. The impeller oscillates to interrupt the flow to the nozzle array. In an optional embodiment, the oscillation of the impeller includes an interruption period and a flow period. In one version of such an optional embodiment, the interruption period of the oscillation may be based at least on the volume of the inflow into the commutator valve. Additionally or alternatively, the frequency of the oscillation may be based on at least the pressure of the inflow. In an optional embodiment, a diverter valve may connect each nozzle assembly to its respective outlet port, thereby bypassing the impeller.

The present invention also includes a system for injecting a material into a ground surface. Again, the material may be a mixture of polymer and water. Such a system may include a mixing tank communicating with an injector pump. The injector pump is downstream of the mixing tank such that the injector pump delivers material from the mixing tank. A surge tank may be disposed in communication with, and downstream of, the injector pump.

A manifold device receives an inflow from the injector pump. In an optional embodiment, an injector system may include multiple manifold devices. In one optional embodiment, the manifold device may be substantially as described above. In another optional embodiment, the manifold device includes a commutator valve having an inlet in communication with the inflow and at least two outlet ports. A first nozzle array communicates with one of the outlets and the second nozzle array communicates with a different outlet port. Additionally, a first impeller is disposed between the commutator valve and the first nozzle array and a second impeller is disposed between the commutator valve and the second nozzle array. The first impeller and second impeller are adapted to oscillate to interrupt the flow to the first nozzle array and second nozzle array, respectively. As above, in one optional embodiment, the oscillation includes an interruption period and a flow period. In one such embodiment, the interruption period of the oscillation may be based at least on the volume of the inflow into the commutator valve. Likewise, in an optional embodiment, the frequency of the oscillation may be based on at least the pressure of the inflow. Optionally, a first diverter valve may connect the first nozzle assembly to the outlet port bypassing the first impeller and a second diverter valve may connect the second nozzle assembly to the outlet port bypassing the second impeller.

An actuator communicates with the commutator valve. The actuator directs a pulse of the material through the commutator valve to a selected outlet port. Optionally, a controller communicates with the actuator to select an outlet port through which a pulse of the material is delivered.

In an optional embodiment, the system includes a movable platform supporting first nozzle array and the second nozzle array. In one such optional embodiment, the system includes motion detectors on the platform to detect the motion of the platform relative to the ground surface and a controller in communication with the actuator and the motion detectors. In such an optional embodiment, the controller selects an outlet port through which a pulse of the material is delivered, based at least in part on the motion of the platform detected by the motion detectors.

### BRIEF DESCRIPTION OF THE DRAWINGS

FIG. 1A is a block diagram of an embodiment of an injection system according to the present invention;

FIG. 1B is a block diagram of an embodiment of an optional extension to an injector system according to the present invention;

FIG. 2 is a block diagram of an embodiment of an injector system according to the present invention.

### DESCRIPTION

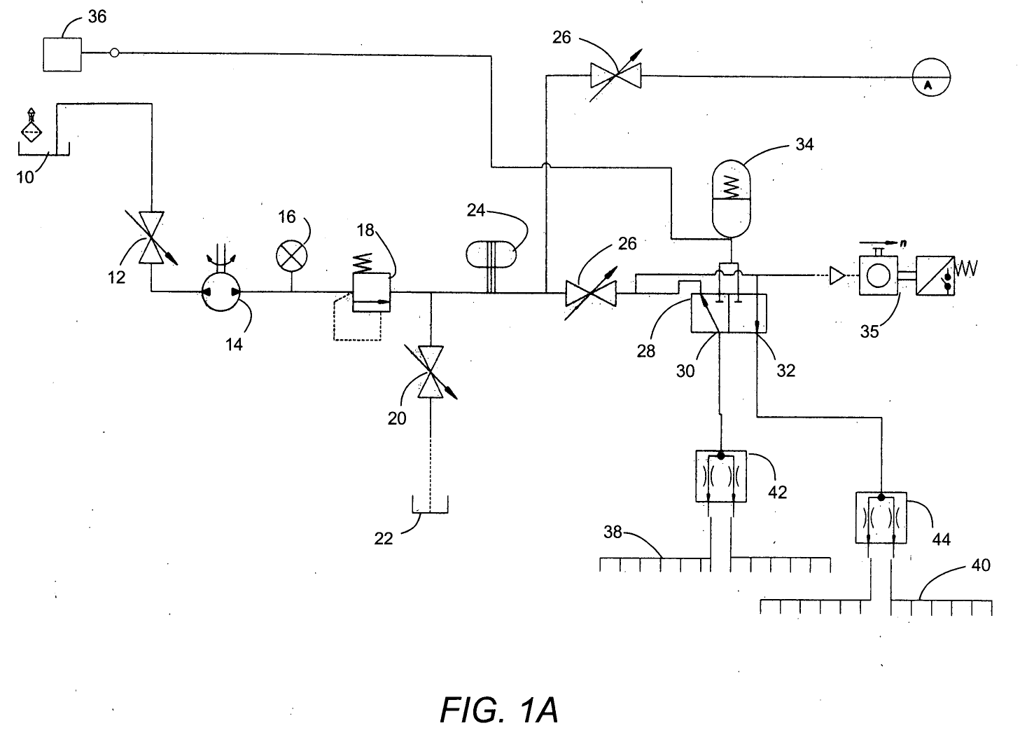

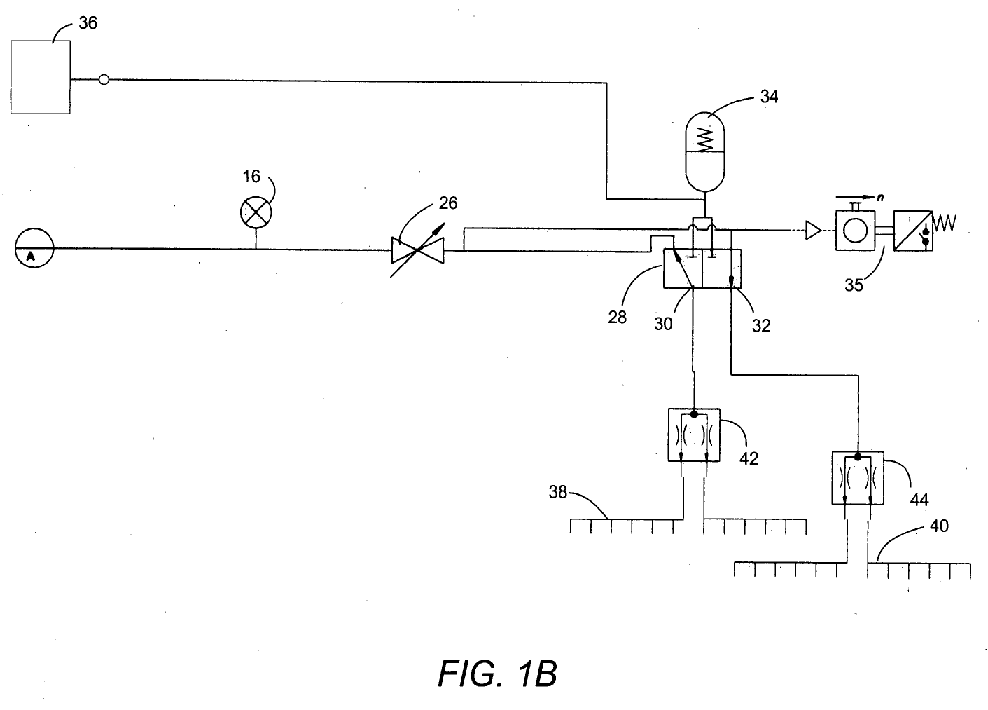

Reference is now made to the figures wherein like parts are referred to by like numerals throughout. Referring first to FIGS. 1A and 1B, the present invention is an injection system for injecting a material beneath a ground surface and a manifold device for an injection system. As shown in FIGS. 1A and 1B, a system may include a mixing tank 10 holding a supply of the material to be injected. Optionally the material is a mixture of water and polymer. In an optional embodiment, the material is stored in the mixing tank. In another optional embodiment, components of the material are supplied to the mixing tank from separate sources and mixed therein. For example, in one optional embodiment, a water source in the form of a water tank or a water supply line could provide water to the mixing tank 10, and a polymer tank could supply polymer to the mixing tank 10. In an optional embodiment, the mixing action is provided by aeration of the material in the mixing tank 10, a fixed or rotational liquid spray, a mechanical mixer, or the like. Optionally, a tank cut-off valve 12 may be provided to isolate the mixing tank 10 from the system.

In another optional embodiment, a mixing tank 10 is not needed and the material may be mixed through an inline mixing valve or a sequential additive manifold that mixes components of the material inline. For example, in one optional embodiment, one or more sources may feed into a sequential additive manifold that combines the components supplied from the sources and, in an optional embodiment, mixes the components with a carrier medium to form the material to be injected.

The material delivered to the injector may take many different forms. As noted above, in an optional embodiment, the material includes a polymer mixed with water. In such an optional embodiment, the polymer may take many forms. In an optional embodiment, the polymer is a hydrophilic polymer. For example, the polymer may be a polyacrylamide copolymers that is cross-linked or non-cross-linked. In another example, the polymer may be impregnated polymers. Such an impregnated polymer could be formed by embedding an additive, such as a chemical, fertilizer, erosion control agent, anti-dust agent, anti-static or static discharging agent, color or dye agent, or the like, into a polymer, optionally a standard polymer or cross-linked polymer. Thus, it is contemplated that the polymer and the form of any impregnated agents could vary depending on the application.

In other optional embodiments, the material to be injected could take other forms, including a carrier medium, such as a liquid, bearing chemical additives; biological additives, such as bacteria, spores, molds, viruses, or the like; mechanical, electrical, or electro-mechanical nano-technology devices; or any other solid, liquid, or gas. In this regard, it is noted that the manifold device and injector system described herein could be pre-assembled or assembled on-demand since the implementation of the manifold device or injector system may be different depending on the application.

An injector pump 14 communicates with the mixing tank 10. The injector pump 14 could take any form. For example, in one optional embodiment, the injector pump is capable of producing pressures of up to 3,000 psi in the material delivered from the mixing tank. In an optional embodiment, an injection system may include a pressure gauge 16 and/or pressure regulator 18 to aid the operator in using the injection system. An injection system may also include a drain valve 20 leading to a drain 22.

Optionally, a surge tank 24 is downstream of, and in communication with, the injector pump 14. The surge tank 24 optionally includes a diaphragm that absorbs surges in the material from the injector pump 14 to reduce pressure hammer effects.

A manifold device is in communication with, and downstream of, the injector pump 14. Optionally, flow to the manifold device passes through a manifold valve 26. The manifold device includes a commutator valve 28 with an inlet receiving an inflow from the injector pump 14 and at least two outlet ports 30, 32. As described in greater detail below, the quantity of outlet ports may be increased if more nozzle arrays are desired for the injection of the material.

The commutator valve 28 receives inflow of the material through the inlet and cyclically distributes the mixture to the outlet ports 30, 32. In one optional embodiment, the commutator valve 28 includes a T-valve actuated to distribute the material between two outlet ports 30, 32. In another optional embodiment, the commutator valve 28 includes a piston resistor actuated to direct the flow to two outlet ports 30, 32.

An actuator 34 works in combination with the commutator valve 28. The actuator 34 causes the commutator valve 28 to distribute the inflow. In one optional embodiment, the actuator 34 is a solenoid. In another optional embodiment, the actuator 34 is a double solenoid. As may be appreciated, if a single action solenoid is used, the commutator valve 28 may include multiple solenoids, with one solenoid actuating flow to each outlet port 30, 32. If a double solenoid is used, the commutator valve 28 may include one double solenoid for every two outlet ports 30, 32.

The actuator 34 directs pulses of material through the outlet ports 30, 32. Optionally, this occurs by periodically permitting and restricting flow to the outlet ports 30, 32. In an optional embodiment, the pulses are variable from less than one second up to several seconds. In one such optional embodiment, the actuator 34 alternates between the outlet ports 30, 32 with flow to one outlet port permitted while flow to another outlet port is restricted.

Optionally, a controller 36 communicates with the actuator 34. The controller 36 could take many different forms. For example, the controller 36 could be an embedded device, or could be separate from the manifold device such as a PDA, cell phone, computer, or other device communicating with the actuator 34. In an optional embodiment, the controller 36 includes a data processor that executes instructions directing the data processor to actuate the actuator 34. In this manner, the flow, including the timing and duration of the pulses, of material through the outlet ports can be controlled using the controller 36. In another optional embodiment, the controller 36 is analog in that it uses a cam and timing shaft to control the actuator 34. Optionally, the manifold device may communicate with a pulse counter 35.

It is also noted that in an optional embodiment described in greater detail below, a system may include multiple manifold devices. These manifold devices may include controllers that communicate with one another, such as through a wired or wireless link, to coordinate the pulses of material delivered to their respective nozzle arrays.

As alluded to above, each outlet port 30, 32 communicates with a nozzle array 38, 40. Each nozzle array 38, 40 could include one or more nozzles. A flow divider 42, 44 may be disposed upstream of the nozzle array 38, 40 to distribute the flow of material through the nozzles of the nozzle array 38, 40. The nozzle array 38, 40 could have any configuration. In an optional embodiment, the nozzles are oriented adjacent one another in a linear array.

In an optional embodiment, the nozzle array 38, 40, alone or with the rest of the manifold device, may be mounted on a movable platform. The movable platform could take any form, such as a trailer, cart, or the like. In an optional embodiment, the movable platform may include motion detectors communicating with a controller 36 such as that described above. In such an optional embodiment, the controller 36 may control the actuator 34 to direct pulses of the material to the nozzle arrays 38, 40 based at least in part on the motion of the platform with respect to the ground surface.

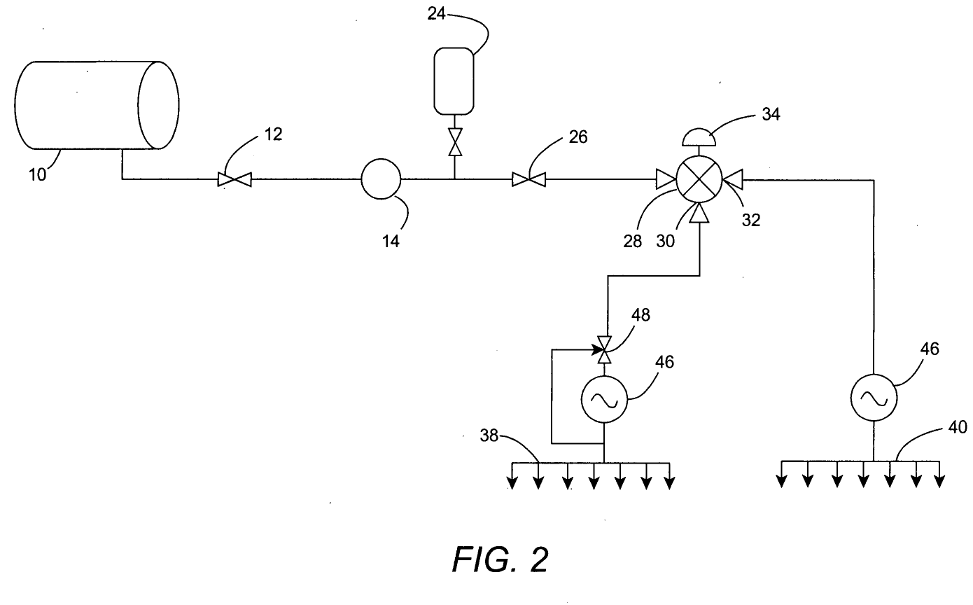

In an optional embodiment, such as that shown in FIG. 2, an impeller 46 may be disposed upstream of one or more of the nozzle arrays 38, 40. In such an optional embodiment, the impeller 46 oscillates to interrupt flow of the material to the nozzle array 38, 40. The oscillation of the impeller 46 may be controlled in any fashion. For example, in an optional embodiment, the oscillation is broken up into an interruption period (the time which the impeller prevents flow) and a flow period (the time which the impeller permits flow), which are each controlled. In an optional embodiment, the interruption period is a function of at least the volume of inflow into the commutator valve 28. Additionally or alternatively, the frequency of the oscillation, i.e. the number of interruption/flow cycles per unit time, may be a function of the pressure of the inflow into the commutator valve 28. In an optional embodiment including an impeller 46, the manifold device may include a diverter valve 48 connecting a nozzle array 38 with the outlet port 30 bypassing the impeller 46.

Referring again to FIGS. 1A and 1B, as alluded to above, a system according to the present invention could include multiple manifold devices. Optionally, each manifold device is supplied from a single mixing tank 10 and injector pump 14, with the flow to each manifold device controlled using separate manifold valves 26. In one such optional embodiment, each manifold device is mounted on a movable platform. In an optional embodiment, multiple different manifold devices may be mounted on different types of platforms. For example, in the optional embodiment of FIGS. 2A and 2B, FIG. 2A illustrates an optional embodiment of a manifold device mountable on a trailer while FIG. 2B illustrates an optional embodiment of a manifold device mountable on a cart. While these manifold devices could be substantially similar as shown in the optional embodiment shown in FIGS. 2A and 2B, in another optional embodiment (not shown) the manifold device mountable on a cart differs from the manifold device mountable on a trailer in that the manifold device mountable on a trailer includes impellers 46 while the manifold device mountable on a cart does not. It is noted, however, that the manifold device could be stationary rather than mobile and, as such, may be mounted on a floor or stationary platform rather than a movable platform.

While certain embodiments of the present invention have been shown and described it is to be understood that the present invention is subject to many modifications and changes without departing from the spirit and scope of the invention presented herein.

I claim:

1. A multi-port manifold device for an injector device receiving a pressurized inflow of material, comprising:
a commutator valve having an inlet in communication with said inflow and at least two outlet ports;
an actuator in communication with said commutator valve, said actuator adapted to direct a pulse of said material through said commutator valve to a selected outlet port; and
a first nozzle array and a second nozzle array, said first nozzle array in communication with one of said outlet ports and said second nozzle array in communication with a different outlet port.

2. The device of claim 1 further comprising an impeller disposed between said commutator valve and said first nozzle array, said impeller adapted to oscillate to interrupt said material flowing to said first nozzle array.

3. The device of claim 2 wherein said oscillation includes an interruption period and a flow period, and wherein the interruption period of said oscillation is based at least on the volume of said inflow into said commutator valve.

4. The device of claim 2 wherein the frequency of said oscillation is based on at least the pressure of said inflow.

5. The device of claim 2 further comprising a diverter valve connecting said first nozzle assembly to said outlet port bypassing said impeller.

6. The device of claim 2 further comprising an impeller disposed between said commutator valve and said second nozzle array, said impeller adapted to oscillate based on at least the volume of said inflow to interrupt said material flowing to said second nozzle array.

7. The device of claim 1 further comprising a controller in communication with said actuator to select an outlet port through which a pulse of said material is delivered.

8. A manifold device for an injector device receiving a pressurized inflow of a mixture of polymer and water, comprising:
a commutator valve having an inlet in communication with said inflow of said mixture and at least two outlet ports;
an actuator in communication with said commutator valve, said actuator adapted to direct a pulse of said mixture through said commutator valve to a selected outlet port;
a first nozzle array and a second nozzle array, said first nozzle array in communication with one of said outlet ports and said second nozzle array in communication with a different outlet port;
a first impeller disposed between said commutator valve and said first nozzle array, said first impeller adapted to oscillate to interrupt said mixture flowing to said first nozzle array; and
a second impeller disposed between said commutator valve and said second nozzle array, said second impeller adapted to oscillate to interrupt said mixture flowing to said second nozzle array.

9. The device of claim 8 wherein said oscillation includes an interruption period and a flow period, and wherein the interruption period of said oscillation is based at least on the volume of said inflow of said mixture into said commutator valve.

10. The device of claim 8 wherein the frequency of said oscillation is based on at least the pressure of said inflow of said mixture.

11. The device of claim 8 further comprising a first diverter valve connecting said first nozzle assembly to said outlet port bypassing said first impeller.

12. The device of claim 8 further comprising a second diverter valve connecting said second nozzle assembly to said outlet port bypassing said second impeller.

13. The device of claim 8 further comprising a controller in communication with said actuator to select an outlet port through which a pulse of said mixture is delivered.

14. A system for injecting a mixture of polymer and water into a ground surface, comprising:
a mixing tank containing said mixture of polymer and water;
an injector pump in communication with said mixing tank, said injector pump downstream of said mixing tank such that said injector pump delivers said mixture of polymer and water from said mixing tank;
a surge tank in communication with, and downstream of, said injector pump; and
a manifold device receiving an inflow of said mixture of polymer and water from said injector pump, said manifold device comprising:
a commutator valve having an inlet in communication with said inflow of said mixture and at least two outlet ports;
an actuator in communication with said commutator valve, said actuator adapted to direct a pulse of said mixture through said commutator valve to a selected outlet port;
a first nozzle array and a second nozzle array, said first nozzle array in communication with one of said outlet ports and said second nozzle array in communication with a different outlet port;
a first impeller disposed between said commutator valve and said first nozzle array, said first impeller adapted to oscillate to interrupt said mixture flowing to said first nozzle array; and
a second impeller disposed between said commutator valve and said second nozzle array, said second impeller adapted to oscillate to interrupt said mixture flowing to said second nozzle array.

15. The system of claim 14 wherein said oscillation includes an interruption period and a flow period, and wherein the interruption period of said oscillation is based at least on the volume of said inflow of said mixture into said commutator valve.

16. The system of claim 14 wherein the frequency of said oscillation is based on at least the pressure of said inflow of said mixture.

17. The system of claim 14 further comprising a first diverter valve connecting said first nozzle assembly to said outlet port bypassing said first impeller.

18. The system of claim 14 further comprising a second diverter valve connecting said second nozzle assembly to said outlet port bypassing said second impeller.

19. The system of claim 14 further comprising a controller in communication with said actuator to select an outlet port through which a pulse of said mixture is delivered.

20. The system of claim 14 further comprising a movable platform supporting first nozzle array and said second nozzle array.

21. The system of claim 20 further comprising:
motion detectors on said platform to detect the motion of said platform relative to said ground surface; and
a controller in communication with said actuator and said motion detectors such that said controller controls said actuator to select an outlet port through which a pulse of said mixture is delivered based at least in part on the motion of said platform detected by said motion detectors.
